(19) United States
(12) Patent Application Publication
(10) Pub. No.: US 2010/0308497 A1
(43) Pub. Date: Dec. 9, 2010

(54) TOOL FOR MAKING MICROSTRUCTURED ARTICLES

(76) Inventor: Moses M. David, Woodbury, MN (US)

Correspondence Address: 3M INNOVATIVE PROPERTIES COMPANY, PO BOX 33427, ST. PAUL, MN, 55133-3427, US

(21) Appl. No.: 12/675,806

(22) PCT Filed: Sep. 2, 2008
(86) PCT No.: PCT/US08/75021

§ 371 Date: Mar. 1, 2010

Related U.S. Application Data
(60) Provisional application No. 60/967,622, filed on Sep. 6, 2007.

(51) Int. Cl. B29C 33/40; H05H 1/24

(52) U.S. Cl. 264/224; 427/569

(57) ABSTRACT

A method for making a microstructured article, including (1 forming a first microstructured pattern on a substrate; (2) replicating the first microstructured pattern to make a second microstructured pattern in a flexible material; (3) replicating the second microstructured pattern multiple times to form a third microstructured pattern in a crosslinkable material to make a tool on a first carrier; and (4) replicating the third microstructured pattern in a polymer to make at least one microstructured article.

### TECHNICAL FIELD

The invention relates to methods for making a tool suitable for making a microstructured article, as well as a process for using the tool to make a microstructured article.

### BACKGROUND

Articles with a microstructured topography include a plurality of structures on a surface thereof (projections, depressions, grooves and the like) that are microscopic in at least two dimensions. The microstructured topography may be created in or on the article by any contacting technique, such as, for example, casting, coating or compressing. Typically, the microstructured topography may be made by at least one of: (1) casting on a tool with a microstructured pattern, (2) coating on a structured film with a microstructured pattern, such as a release liner, or (3) passing the article through a nip roll to compress the article against a structured film with a microstructured pattern.

The topography of the tool used to create the microstructured pattern in the article or film may be made using any known technique, such as, for example, chemical etching, mechanical etching, laser ablation, photolithography, stereolithography, micromachining, knurling, cutting or scoring. The machine tool industry is capable of creating a wide variety of patterns required to make microstructured articles, and Euclidean geometric patterns can be formed with varying patterns of size, shape, and depth/height of projections. Tools can range from planar presses to cylindrical drums and other curvilinear shapes.

However, machining a metal tool to make a microstructured article to a customer's specification can be a time consuming process. In addition, once a metal tool is machined, it is difficult and expensive to alter the microstructured pattern in response to changing customer requirements. This machining time can introduce production delays and increase overall costs, so methods are needed to reduce the time required to make a tool suitable for the production of microstructured articles.

### SUMMARY

In general, the present disclosure describes processes for making microstructured tools that do not require traditional metal machining steps. In this process, a replication tool is prepared by using a microstructured array as a masterform. A flexible material is placed against the masterform and subsequently removed from the masterform to prepare a self-supporting patterned stamp with a reverse image of the masterform array. In one embodiment, the patterned stamp made of the flexible material may be used at least one time as a mold insert to prepare additional microstructured articles, each including the microstructured pattern from the masterform. In another embodiment, a crosslinkable material is placed against the stamp to form at least one stamp element in which the masterform array is replicated. Single or multiple stamp elements from the same or different masterforms may be arranged on a carrier to form a replication tool made of the second material. The replication tool may be used in a substantially continuous or stepwise continuous process to make at least one microstructured article.

In one aspect, the present disclosure is directed to a method for making a microstructured article, including: (1) forming a first microstructured pattern on a substrate; (2) replicating the first microstructured pattern to make a second microstructured pattern in a flexible material; (3) replicating the second microstructured pattern multiple times to form a third microstructured pattern in a crosslinkable material to make a tool on a first carrier; and (4) replicating the third microstructured pattern in a polymer to make at least one microstructured article.

In another aspect, the present disclosure is directed to a method for making a microstructured article, including: (1) creating a masterform, wherein the masterform is created by forming with a multiphoton photofabrication process a first microstructured pattern in a polymer disposed on a substrate; (2) applying to the masterform a layer of a flexible material, wherein the flexible material comprises at least one of a fluoropolymer and a silicone; (3) removing the layer of the flexible material, wherein the layer of flexible material forms a stamper with a second microstructured pattern, and wherein the second microstructured pattern is a reverse of the first microstructured pattern on the masterform; (4) applying a layer of a radiation curable material on at least one stamper and placing the layer of radiation curable material in contact with a carrier; (5) curing the radiation curable material through the stamper; (6) removing the stamper to form a tool on the carrier with at least one stamp element, wherein at least one stamp element on the tool comprises a third microstructured pattern; and (7) substantially continuously replicating the third microstructured pattern in a polymer to make a structured article.

Since the processes described herein for microstructured tool making do not require complex machining steps, tools with complex microstructured topographies may be created more rapidly, which reduces pre-production time and associated costs. The processes described herein also allow microstructured patterns in tools to be more easily and rapidly changed in response to customer requirements.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

FIGS. 1A-1B are schematic illustrations of method steps in which a masterform is made.

FIGS. 2A-2C are schematic illustrations of method steps in which a stamper is made from the masterform.

FIGS. 3A-3D are schematic illustrations of method steps in which a stamp element is created from the stamper.

FIG. 4 is a schematic illustration of a tool made from a plurality of stamp elements.

FIG. 5 is a schematic illustration of a tool mounted to a rotating drum.

FIG. 6 is a schematic representation of a microstructured article made from an embodiment of the method described herein.

FIG. 7 is a flow chart illustrating various embodiments of the method described herein.

### DETAILED DESCRIPTION

The present disclosure is directed to a process for making a replication tool that may subsequently be used to make a microstructured article. As noted above, microstructured articles have a microstructured topography with structures on a surface thereof (projections, depressions, grooves and the like) that are microscopic in at least two dimensions. The term microscopic as used herein refers to dimensions that are difficult to resolve by the human eye without aid of a microscope. One useful definition of microscopic is found in Smith, Modern Optic Engineering, (1966), pages 104-105, wherein visual acuity is defined and measured in terms of the angular size of the smallest character that can be recognized. Normal visual acuity allows detection of a character that subtends an angular height of 5 minutes of arc on the retina. In some cases, a dimension of a microstructure is less than 1000 microns, or less than 500 microns, or less than 200 microns, or less than 100 microns.

The process described herein initially requires formation of a microstructured patterns, such as a microstructured array, on a substrate to create a masterform. Typically, the microscopic structures in the array may be designed and arranged using computer aided design and manufacturing (CAD/CAM) software that is well known in the art.

Once designed, the pattern may be created in a suitable material by any of a number of processes using any suitable technique such as, for example, a multiple-photon such as a two-photon exposure process, chemical or mechanical etching, laser ablation, photolithography, stereolithography, micromachining, knurling, cutting, scoring, engraving, diamond turning, and the like. Any process or combination of processes may be used, as long as it is sufficiently precise to flexibly and controllably provide patterns with structures of a variety of sizes, geometric configurations, and/or surface profiles. The patterns may include, for example, protruding structures, recessed structures, continuous and discontinuous grooves, and combinations thereof. The patterns formed by the structures may be regular or irregular, and the individual structures in these patterns may be same or different in one or more shapes, angles or dimensions.

The substrate used to make the masterform can vary widely. In some cases, any substrate material may be used that is sufficiently rigid, flat and stable to allow accurate creation of the microstructured array. In general, any substrate may be used that allows accurate formation of microstructures. Suitable substrate materials include, but are not limited to metal plates, silicon wafers, glass, quartz or rigid or flexible polymeric materials.

Copending and commonly assigned U.S. Application Ser. No. 60/747,609 (3M File No. 62162US002), which is incorporated by reference herein in its entirety, describes multiphoton photofabrication processes that are particularly well suited to create microstructured arrays in a polymeric material that exhibit at least some variation in at least one shape factor within the array and/or exhibit a non-uniform distribution of structures. Multiphoton photofabrication makes possible formation of microstructured arrays having structures that are non-uniform, and in which at least one shape factor (preferably, height) varies at least somewhat (preferably, continuously) across the array. Shape factors can be said to be different when the height (or another dimension) and/or the geometric configuration of at least one structure is different from that of at least one other structure in the array. Geometric configurations can be said to be different when two structures in the array cannot be scaled to be superimposable. For example, the areal density of the array of structures may increase as the height of the structures increases across the array.

For example, the multiphoton photofabrication process can be used to fabricate arrays with structures having heights in the range of about 5 nm to about 300 microns (preferably, about 50 microns to about 200 microns; more preferably, about 75 microns to about 150 microns) and/or maximum lengths and/or maximum widths in the range of about 5 microns to about 500 microns (preferably, about 50 to about 300; more preferably, about 100 to about 300). A wide range of fill factors (up to 100 percent) can be achieved. For many applications, fill factors of about 1 percent to 100 percent (preferably, about 5 percent to 50 percent) can be useful.

Structures having various geometric configurations (for example, cones and truncated cones) can be fabricated with array fill factors up to 100 percent. The configurations can be complex (for example, combining segments of multiple shapes in a single structure, such as a stacked combination of a cone and a pyramid or of a cone and a “Phillips head” shape). Geometric configurations can comprise such structural elements as a base, one or more faces (for example, that form a side wall), and a top (which can be, for example, a planar surface or even a point). Such elements can be of essentially any shape (for example, bases, faces, and tops can be circular, elliptical, or polygonal (regular or irregular), and the resulting side walls can be characterized by a vertical cross section (taken perpendicular to the base) that is parabolic, hyperbolic, or linear in nature, or a combination thereof). Preferably, the side wall is not perpendicular to the base of the structure (for example, angles of about 10 degrees to about 80 degrees (preferably, 20 to 70; more preferably, 30 to 60) can be useful). The structures can have a principal axis connecting the center of its top with the center of its base. Tilt angles (the angle between the principal axis and the base) of up to about 80 degrees (preferably, up to about 25 degrees) can be achieved.

The fill factor of the arrays can be varied, while the packing arrangement or distribution of the structures can be regular (for example, square or hexagonal) or irregular. The shape factors of the structures in the array can also vary throughout the array. For example, the heights can be varied according to the distance of a particular structure from a particular point or line. In some cases, an array can be an irregular, such as a random, array. In some cases, a structure in an array can be different than another structure in the array.

Multiphoton photofabrication can also be used to fabricate arrays including at least two structures that have non-parallel principal axes. Such arrays can exhibit an independent variation in tilt angle from structure to structure across the array.

Multiphoton photofabrication can be used to fabricate microstructured array masterforms with multiple structure designs in a single writing process. Multiphoton photofabrication includes providing a photoreactive composition, the photoreactive composition including (a) at least one reactive species that is capable of undergoing an acid- or radical-initiated chemical reaction, and (b) at least one multiphoton photoinitiator system. The reactive species is preferably a curable species (more preferably, a curable species selected from monomers, oligomers, and reactive polymers). At least a portion of the composition can be imagewise exposed to light sufficient to cause simultaneous absorption of at least two photons, thereby inducing at least one acid- or radical-initiated chemical reaction where the composition is exposed to the light.

Suitable reactive species, photoinitiators, and apparatuses for conducting multiphoton photofabrication are described in copending and commonly assigned application U.S. Ser. No. 60/747,609 (3M File No. 62162US002), which is incorporated by reference herein in its entirety.

The imagewise exposing can be carried out in a pattern that is effective to at least partially cure and/or crosslink portions of the composition and define at least the surface of an array of microstructures. The composition can optionally be developed by removing the resulting exposed portion, or the resulting non-exposed portion, of the composition. Optionally, after imagewise exposing at least a portion of the composition, at least a portion of the composition can be nonimagewise exposed to light sufficient to effect reaction of at least a portion of any remaining unreacted photoreactive composition.

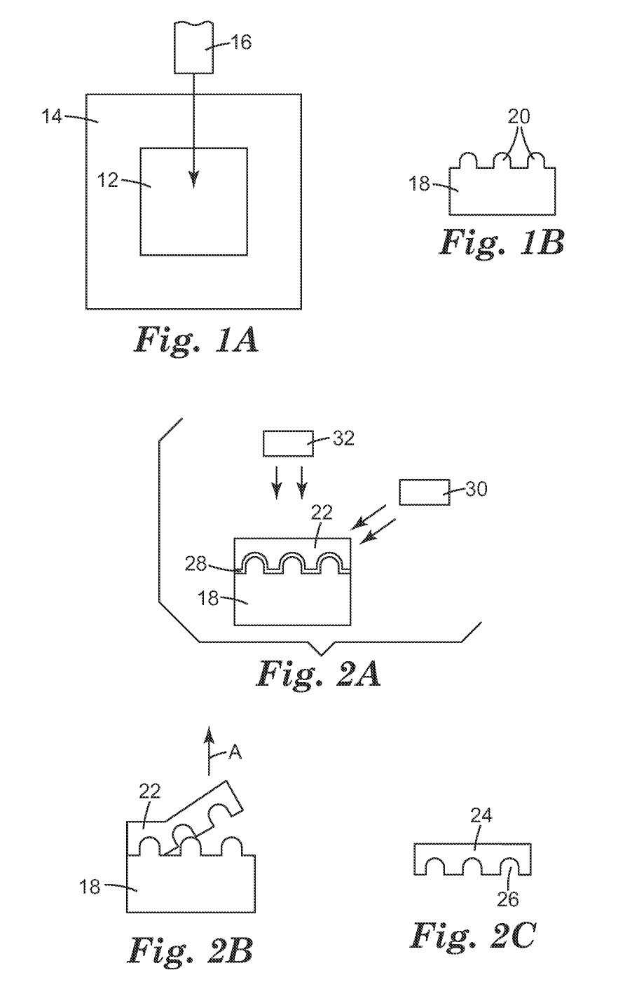

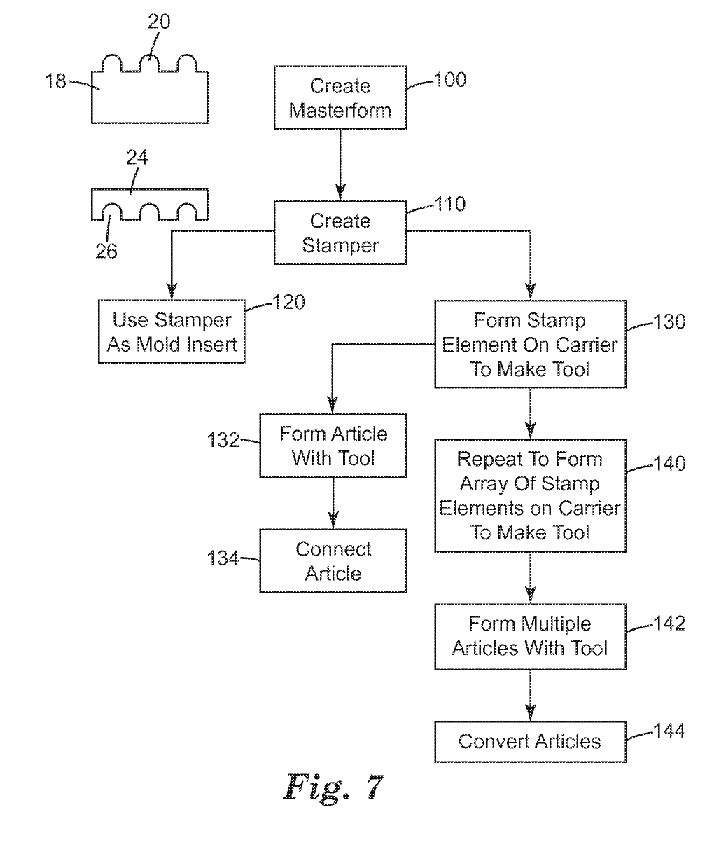

In one embodiment of the process 10 illustrated in FIG. 7, in a first step 100 a multiphoton photofabrication process is used to imagewise expose with an ultrafast laser 16 a multiphoton curable composition 12 placed on a supporting substrate 14 (See FIG. 1A) The composition 12 at least partially cures and or crosslinks in certain areas to form in the composition an array of microstructures. As shown in FIG. 1B, the non-exposed portion of the composition is then removed using a suitable solvent, and the remaining material creates a masterform 18 with a first structured pattern 20 corresponding to the microstructured array.

A wide variety of supporting substrates 14 may be used to support the multiphoton curable composition 12 during the exposure process, but the supporting substrate is preferably substantially flat to form a reference plane so the composition may be accurately exposed to form the structured pattern. In some cases, the substrate can be flexible, such as a flexible polymeric substrate. Suitable substrates include, for example, silicon wafers, quartz and metal electroforms. Materials with high contrast, such as metals having high reflectivity, are particularly preferred to provide feedback regarding the accurate location of the light beam forming the structures in the multiphoton polymerizable material on the substrate.

Referring to FIG. 2A and FIG. 7, once the masterform 18 is created with the first structured pattern 20 thereon, a stamper is created in a second step 110. In the second step 110 a layer of a flexible material 22 is applied on the masterform 18 to completely cover and/or fill the first structured pattern 20. As shown in FIG. 2B, the flexible material 22 is subsequently removed from the masterform by peeling in the direction A to create a stamper 24 (FIG. 2C) having a reverse image 26 of the microstructured pattern 20 from the masterform 18. In some cases, stamper 24 is self-supporting and flexible.

In the present application, flexible refers to materials that may be removed by peeling them away from the masterform at an angle of at least about 30°, preferably at least about 45-60°, measured with respect to a planar surface of the masterform, without damage, such as cracking, deformation or altering the microstructured pattern replicated therein. The flexible material may be removed from the masterform by lifting the flexible material around its perimeter or by peeling up one leading edge thereof. The peel rate may vary widely depending on the flexible material, the masterform material, and the density of microstructures in the masterform. Generally, the higher the density of microstructures in the masterform, the more slowly the flexible material should be removed from the masterform.

Optionally, a layer of a suitable release material 28 such as, for example, a fluorocarbon, may be applied on the masterform 18 prior to application of the flexible material 22. The first material may vary widely, but an elastomeric resin is particularly useful. Suitable elastomeric resins include, for example, fluoropolymers and silicones.

Suitable fluoropolymers include, but are not limited to, the fluoropolyethers described in U.S. Published Applications 2005/0273146 and 2005/0271794, which are incorporated herein by reference in their entirety. Preferred fluoropolyethers include perfluoropolyethers, particularly perfluoropolyether diols available from Solvay-Solex Spa, Italy, under the trade designation Fomblin, particularly Fomblin 4000, which are perflouropolyether diols having a weight average molecular weight of approximately 3800.

In one embodiment, the diol end group is methacrylate functionalized by reacting it with, for example, isocyanatoethyl methacrylate (IEM) to form a reactive oligomer according to the method described in Bongiovanni et al., Macromol. Chem. Phys. 198, 1893 (1997), which is incorporated by reference herein in its entirety. In one embodiment, the resulting methacrylate functionalized reactive adduct may be mixed with any suitable photoinitiator such as, for example, Lucirin TPO-L from BASF, to form a radiation curable resin.

The resin used to form the flexible material 22 may optionally be degassed either before or after it is applied to the masterform 18, and following application the elastomeric resin may be cured by any suitable technique. For example, in one embodiment the radiation curable resin described above may be cured by a source of actinic radiation 30 (FIG. 2A) to form the layer of the flexible material 22.

Suitable silicones for use in making the layer of flexible material 22 include, but are not limited to, polydimethyl siloxane, silicone elastomers available from Dow Corning under the trade designation Sylgard, those available under the trade designation RTV from General Electric Co., Waterford, N.Y., and those described in U.S. application Ser. No. 11/845,465, which is incorporated herein by reference in its entirety. Of the above, two part silicones such as GE RTV 615A and 615B are particularly preferred.

In another embodiment shown in FIG. 2A, the silicone resin 22 may be cured by a heat source 32 that heats the resin from room temperature to a higher temperature sufficiently low to prevent damage to the masterform 18. For example, for a two part silicone the curing temperature is about 1 hour at a temperature of about 60° C. to about 80° C.

Once the flexible material 22 is completely cured by an appropriate method, as shown in FIG. 2B and FIG. 2C the layer of the flexible material 22 is removed from the masterform 18 to create a stamper 24. The stamper is preferably sufficiently thick to form a free-standing film that accurately replicates in the flexible material the first structured pattern 20 from the masterform 18. The stamper 24 thus includes a second structured pattern 26 that is a reverse image of the first structured pattern in the masterform (e.g., if the masterform includes an array of protruding structures, the stamper will have an array of corresponding depressions). Typically, in a preferred embodiment the stamper 24 is a free-standing film with a thickness of about 2 mm to 1 cm, preferably about 2 mm to about 8 mm, and more preferably about 2 mm to about 3 mm.

In one embodiment 120 of the process 10 shown in FIG. 7, the stamper 24 may be used once or multiple times as a mold insert to prepare a microstructured article including the microstructured pattern 20 from the masterform 18. Microstructured articles can be molded from a wide variety of materials including, but not limited to, polycarbonates; polyacrylates such as polymethyl methacrylate; polystyrene; and the like. The microstructured articles preferably are made by, for example, injection molding, reaction injection molding or extrusion replication.

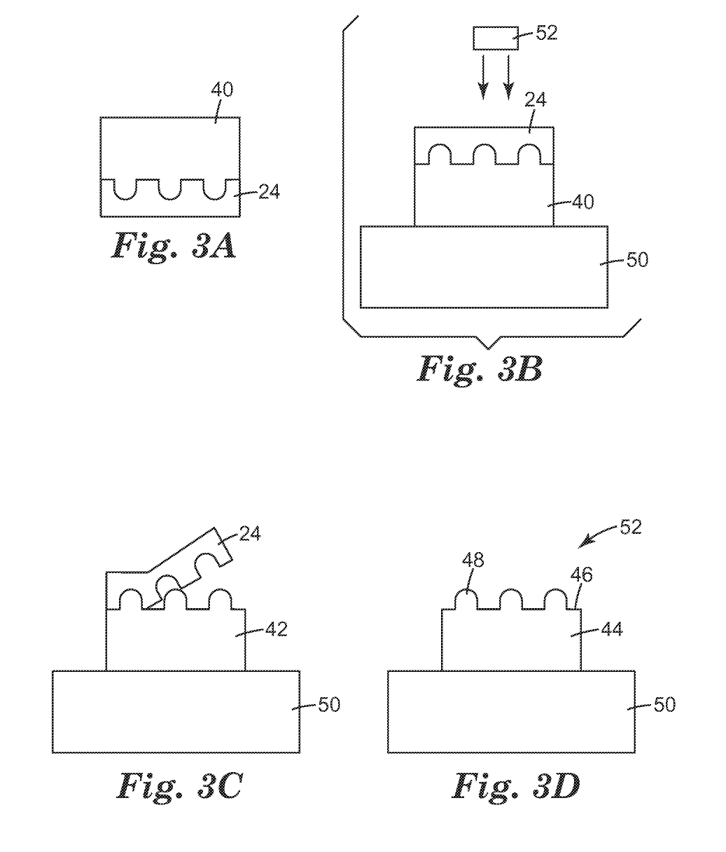

In another embodiment 130 of the process 10 in FIG. 7, as shown in FIG. 3A a layer of a crosslinkable material 40 is applied on the stamper 24 to completely cover or fill the microstructured pattern 26 thereon. A squeegee may optionally be used to remove excess crosslinkable material 40 and ensure complete coverage and/or fill.

The crosslinkable material 40 may be selected from any material curable using actinic radiation, heat or a combination thereof. Preferred crosslinkable materials include those curable with actinic radiation, particularly UV curable materials. For example, blends of urethane acrylate oligomers with diluent monomers are suitable for use as crosslinkable materials. Blends of urethane acrylate oligomers such as those available under the trade designation Photomer 6210 from Cognis Corp., Cincinnati, Ohio, are suitable, which may be blended with reactive diluents such as, for example, those available from Sartomer under the trade designations SR 238, SR 256 and the like. The UV curable crosslinkable materials also include a photoinitiator such as Lucirin TPO-L, which is available from BASF.

As shown in FIG. 3B, the stamper 24, which has its microstructures covered with the layer of the uncured crosslinkable material 40, is then placed such that the layer of the uncured crosslinkable material 40 is in contact with a surface of a carrier 50. Any bubbles in the crosslinkable material are preferably removed using local pressure from, for example, a rubber roller.

Any carrier 50 may be used, and the carrier 50 may flat during the replication, or the carrier 50 may be curved by, for example, being a cylindrical roll. Suitable carriers include, but are not limited to, polymeric films, metal films, and metal plates, metal rolls, polymeric rolls, belts and the like. Flexible and compliant carrier films are preferred, and such flexible carrier films include, but are not limited to, polyethylene terepthalate (PET) and polyimides such as those available from DuPont under the trade designation Kapton. The flexible carrier films may optionally be primed or surface treated using any suitable technique.

After placement on the carrier 50, the uncured crosslinkable material 40 is then cured by any suitable technique to form a cured material 42. Preferably, as shown in FIG. 3B, actinic radiation (typically ultraviolet (UV) radiation) is applied by a source 52 through the stamper 24, although the radiation can be applied from an opposite, or any other suitable, direction. The stamper may then be removed (FIG. 3C), leaving the layer of the cured material 42 behind on the carrier to form a stamp element 44 (FIG. 3D). The exposed surface 46 of the stamp element 44 thus includes a third pattern of microstructures 48 corresponding to the array of microstructures 20 in the original masterform 18.

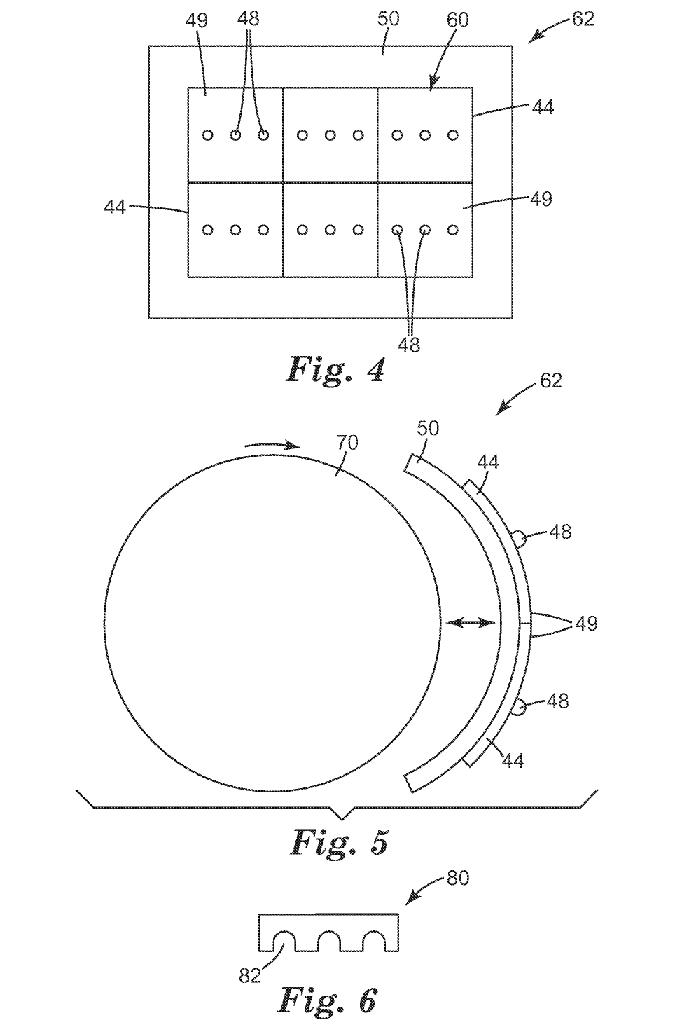

As shown in step 132 in FIG. 7 and FIG. 3D, a single stamp element 44 may be used on the carrier 50 to form a tool 52 to create a microstructured article 80 (FIG. 6) with a microstructured pattern 82 corresponding to the microstructured pattern 20 in the masterform 18. Or, as shown in step 140 in FIG. 7, the stamper may be used multiple times to form a plurality of stamp elements 44 made of the cured crosslinkable material, the plurality of patterns forming a third pattern of microstructures 60. As shown in FIG. 4, the resulting stamp elements 44 may be arranged in a tile-like pattern 60 on the carrier 50 to form a more complex tool 62. The stamp elements 44 including the third pattern of microstructures 48 may optionally be combined on the carrier with stamp elements made from other masterforms (not shown in FIG. 4) to create a tool with a widely varying microstructured pattern.

As illustrated in step 142 of process 10 in FIG. 7, the microstructures 48 on the exposed surfaces 49 of the tool 62 may then be used to create a plurality of microstructured articles 80 (FIG. 6) using any suitable contacting technique. The contacting process may be substantially continuous (which means that the process does not stop during the replication steps used to make the articles 80) or stepwise continuous (some pauses during replication steps). Substantially continuous processes are preferred.

Examples of stepwise continuous processes include injection molding, resin transfer molding, compression molding and the like. Examples of substantially continuous processes include roll-to-roll processes. For example, as shown in FIG. 5, the tool 62 may be mounted on a rotating drum 70 to create the structured articles on a carrier film using a roll-to-roll process, or the articles may be formed on the tool 62 using an extrusion replication process.

As shown in steps 134/144 of the process 10 in FIG. 7, the resulting article(s) 80 (FIG. 6) may then be converted as necessary by, for example, cutting to size or shape, removing the carrier film or adding a release liner (not shown in FIG. 6). In some cases, the converted articles my remain on a carrier for individual removal at a later time.

Prior to use, the exposed microstructured surfaces 46/49 of the tools 52/62 (See FIGS. 3D and 4) may optionally be surface modified to alter its release properties. For example, the release properties of the tools 52/62 may be tailored over a wide range by depositing a thin film on the exposed surface of the tool from a gas phase using, for example, a plasma treatment process. To alter release properties of the tool surfaces, the plasma deposited thin film typically is about 1 nm to about 1000 nm thick, preferably about 1 nm to about 100 nm thick, and most preferably about 50 to about 100 nm thick.

In one embodiment, the surface of the tool may be treated by plasma deposition of a silicon-containing thin film. For example, the silicon-containing thin film may be amorphous hydrogenated silicon oxycarbide or diamond-like glass. The silicon-containing thin film may be deposited from an organosilane or a silane precursor gas. In some embodiments, the silicon-containing precursor gas is reacted with other gases such as nitrogen (N₂), oxygen (O₂), or combinations thereof. Suitable silicon containing precursor gases include, but are not limited to, tetramethylsilane (TMS), tetraethylorthosilicate (TEOS), hexamethyldisiloxane (HMDSO), silane, etc. Plasma treatments including TMS and O₂ have been found to provide excellent release properties from a wide variety of polymeric surfaces such as, for example, polypropylene.

In another embodiment, the surface of the tool may be treated by plasma deposition of a fluorine-containing thin film. The fluorine-containing thin film may be, for example, amorphous fluorinated carbon deposited from a fluorocarbon precursor gas. A preferred fluorocarbon precursor gas is perfluoropropane. In some embodiments, the fluorine-containing precursor gas is reacted with other gases such as nitrogen (N₂), oxygen (O₂), ammonia, water, or combinations thereof.

Typically, the surface of the tool is plasma treated for about 0.1 minute to about 10 minutes, and treatment times of about 0.1 minute to about 2 minutes are preferred.

As shown in copending U.S. provisional application Ser. No. 60/341,564 incorporated herein in its entirety, the plasma deposition process is typically performed at room temperature in an apparatus with a chamber pumped down to a base pressure of 40 mTorr before the gases are introduced. The tool may be stationary during the plasma treatment process, or may be translated on a carrier at varying speeds.

Exemplary process conditions for treatment of the tool with TMS are as follows: flow rate of 200 sccm; oxygen flow rate of 2000 sccm; pressure: 200 mTorr; power density of 0.12 W/cm²; and plasma treatment time of 30 seconds. If oxygen gas is used, the molar or flow rate ratio of TMS to O₂ in the chamber is about 0.01 to 5, preferably about 0.1 to 1. In some embodiments, the power density can be about 0.01 to 1.0 W/cm², more preferably about 0.1 to 1 W/cm².

Further, prior to use, the exposed microstructured surface of the tool may optionally be metallized to transfer its structured pattern to a suitable metal such as, for example, a Ni based alloy. Metallization using, for example, electroplating, sputtering and the like, may be useful to improve the toughness and durability of the tool.

The tool and manufacturing process described above may be used to make a wide variety of microstructured articles from polymeric materials. Typical articles made by the process described herein include, for example, prismatic structures for light management films, microfluidic devices, sensors, ring resonators, microneedles for transdermal drug delivery, and abrasive articles.

The process described herein is particularly well suited to the manufacture of optical materials such as light guides. For example, light guides including microstructures can be fabricated from a wide variety of materials including polycarbonates; polyacrylates such as urethane acrylates and polymethyl methacrylate; polystyrene; silicone polymers, polyolefins, and thermoplastic urethanes. Optically suitable high refractive index materials such as polyacrylates and polycarbonates are preferred.

The exemplary light guides can be especially useful in backlit displays (for example, including a light source, a light gating device (for example, a liquid crystal display (LCD)), and a light guide) and keypads (for example, comprising a light source, an array of pressure-sensitive switches at least a portion of which transmits light, and a light guide). The light guides are useful as point to area or line to area back light guides for subminiature or miniature display or keypad devices illuminated with light emitting diodes (LEDs) powered by small batteries. Suitable display devices include color or monochrome LCD devices for cell phones, pagers, personal digital assistants, clocks, watches, calculators, laptop computers, vehicular displays, and the like. Other display devices include flat panel displays such as laptop computer displays or desktop flat panel displays. Suitable backlit keypad devices include keypads for cell phones, pagers, personal digital assistants, calculators, vehicular displays, and the like.

Various embodiments of the invention have been described. These and other embodiments are within the scope of the following claims.

1. A method for making a microstructured article, comprising:
(1) forming a first microstructured pattern on a substrate;
(2) replicating the first microstructured pattern to make a second microstructured pattern in a flexible material;
(3) replicating the second microstructured pattern multiple times to form a third microstructured pattern in a crosslinkable material to make a tool on a first carrier; and
(4) replicating the third microstructured pattern in a polymer to make at least one micro structured article.

2. The method of claim 1, wherein the first microstructured pattern is formed in a polymer.

3. The method of claim 2, comprising forming a pattern in the polymer with a two photon photopolymerization process.

4. The method of claim 1, wherein the structured articles are formed on a second carrier, and wherein the second carrier comprises a film.

5. The method of claim 4, further comprising removing each of the structured articles from the second carrier film.

6. The method of claim 1, wherein the replicating in step (4) comprises extrusion replication.

7. The method of claim 1, wherein the flexible material is a self-supporting film.

8. The method of claim 1, wherein the carrier is flexible.

9. The method of claim 8, wherein the flexible carrier comprises one of a metal film or a polymeric film.

10. The method of claim 1, wherein the first carrier comprises a cylinder.

11. The method of claim 10, wherein the first carrier comprises one of a metal roll or a polymeric roll. or a belt.

12. The method of claim 1, wherein the first carrier comprises a belt.

13. The method of claim 1, wherein the replicating in step (4) is substantially continuous.

14. The method of claim 1, wherein the replicating in step (4) is stepwise continuous.

15. The method of claim 1, wherein the flexible material comprises one of a fluoropolymer and a silicone.

16. The method of claim 15, wherein the fluoropolymer is a perfluoropolyether.

17. The method of claim 16, wherein the fluoropolymer is a perfluoropolyether methacrylate.

18. The method of claim 1, wherein the substrate comprises one of a polymer, a metal, a silicon wafer and quartz.

19. The method of claim 7, wherein the film has a thickness of about 2 mm to about 1 cm.

20. The method of claim 1, further comprising depositing a fluorine containing thin film on a microstructured surface of the tool prior to step (4).

21. The method of claim 20, wherein the surface modification comprises a plasma treatment.

22. The method of claim 21, wherein the plasma treatment comprises depositing a fluorine-containing thin film on the tool.

23. The method of claim 22, wherein the fluorine containing thin film comprises an amorphous fluorinated carbon.

24. The method of claim 23, wherein the amorphous fluorinated carbon is deposited from a fluorocarbon precursor gas.

25. The method of claim 22, wherein the precursor gas comprises perfluoropropane.

26. The method of claim 21, wherein the plasma treatment comprises depositing a silicon-containing thin film on the tool.

27. The method of claim 26, wherein the silicon-containing thin film comprises an amorphous hydrogenated silicon oxycarbide.

28. The method of claim 27, wherein the silicon-containing thin film comprises a diamond-like glass.

29. The method of claim 27, wherein the amorphous hydrogenated silicon oxycarbide is deposited from an organosilicon precursor gas.

30. The method of claim 29, wherein the organosilicon precursor gas is tetramethylsilane.

31. The method of claim 30, wherein the tetramethylsilane is mixed with a gas comprising at least one of oxygen, nitrogen, ammonia, and water.

32. The method of claim 31, wherein the gas comprises oxygen.

33. The method of claim 26, wherein the thin film has a thickness of about 1 nm to about 1000 nm.

34. The method of claim 26, wherein the thin film has a thickness of about 10 nm to about 100 nm.

35. The method of claim 1, further comprising electroplating the tool following step (3).

36. A method for making a microstructured article, comprising:
(1) creating a masterform, wherein the masterform is created by forming with a multiphoton photofabrication process a first microstructured pattern in a polymer disposed on a substrate;
(2) applying to the masterform a layer of a flexible material, wherein the flexible material comprises at least one of a fluoropolymer and a silicone;
(3) removing the layer of the flexible material, wherein the layer of flexible material forms a stamper with a second microstructured pattern, and wherein the second microstructured pattern is a reverse of the first microstructured pattern on the masterform;
(4) applying a layer of a radiation curable material on at least one stamper and placing the layer of radiation curable material in contact with a carrier;
(5) curing the radiation curable material through the stamper;
(6) removing the stamper to form a tool on the carrier with at least one stamp element, wherein at least one stamp element on the tool comprises a third microstructured pattern; and
(7) substantially continuously replicating the third microstructured pattern in a polymer to make a structured article.

37. The method of claim 36, wherein the stamper is flexible and self-supporting.

38. The method of claim 36, wherein the fluoropolymer is a perfluoropolyether.

39. The method of claim 36, wherein the fluoropolymer is a perfluoropolyether methacrylate.

40. The method of claim 36, wherein the stamper comprises a silicone.

41. The method of claim 36, further comprising applying a plasma treatment to a microstructured surface of the tool prior to step (7).
